(19) United States
(12) Patent Application Publication
(10) Pub. No.: US 2011/0307831 A1
(43) Pub. Date: Dec. 15, 2011

(54) User-Controlled Application Access to Resources

(75) Inventors: Crispin Cowan, Fall City, WA (US); Christopher John Clark, Seattle, WA (US)

(73) Assignee: Microsoft Corporation, Redmond, WA (US)

(21) Appl. No.: 12/813,385

(22) Filed: Jun. 10, 2010

(51) Int. Cl. G06F 3/048; G06F 9/44

(52) U.S. Cl. 715/823; 715/835; 719/328

(57) ABSTRACT

A host application on a computing device displays an icon or other visual representation of a resource of the computing device, and receives a request from one of one or more applications hosted by the host application. The request is a request to access the resource represented by the icon or other visual representation of the resource, and in response to the request the appearance of the icon or other visual representation of the resource is altered. The requesting application is allowed to access the resource only if a user selection of the displayed icon or other visual representation is received.

### BACKGROUND

Computers are typically capable of running many different applications, and can make numerous resources available to those applications, such as cameras, microphones, storage devices, and so forth. Users oftentimes desire to have some applications access particular resources at certain times, but not other applications and/or at other times. Accordingly, granting applications complete access to resources of the computer, or restricting applications from accessing all resources of the computer, can lead to user frustration with the computer and undesirable user experiences.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, a host application on a computing device receives a request from one of one or more applications hosted by the host application. The request is a request to access a resource of the computing device. A visual representation of the resource (e.g., an icon representing the resource) is displayed with an altered appearance that is different than if the request to access the resource were not received. The requesting application is allowed to access the resource only if a user selection of the displayed visual representation is received.

### BRIEF DESCRIPTION OF THE DRAWINGS

The same numbers are used throughout the drawings to reference like features.

FIG. 1 illustrates an example system implementing the user-controlled application access to resources in accordance with one or more embodiments.

FIGS. 2, 3, and 4 illustrate example displays of icons in accordance with one or more embodiments.

FIG. 5 is a flowchart illustrating an example process for user-controlled application access to resources in accordance with one or more embodiments.

FIG. 6 illustrates an example computing device that can be configured to implement the user-controlled application access to resources in accordance with one or more embodiments.

### DETAILED DESCRIPTION

User-controlled application access to resources is discussed herein. Icons representing different resources in a computing device are displayed. These resources can be, for example, a camera, a microphone, a storage device, and so forth. In order to access a particular resource, an application invokes an application programming interface (API) of a host application that hosts the requesting application and also controls access to the resources in the computing device. The requesting application alters the display of the icon corresponding to the requested resource to indicate to a user of the computing device that access to the resource has been requested. An application icon representing the requesting application can also be displayed to indicate to the user of the computing device that access to the resource has been requested by that particular requesting application. If the user desires to allow the requesting application to access the requested resource, then the user can simply select the icon corresponding to the requested resource. If the user does not desire to allow the requesting application to access the requested resource, then the user can simply not select the icon corresponding to the requested resource. The user is thus in control of whether a particular requesting application can access a particular resource.

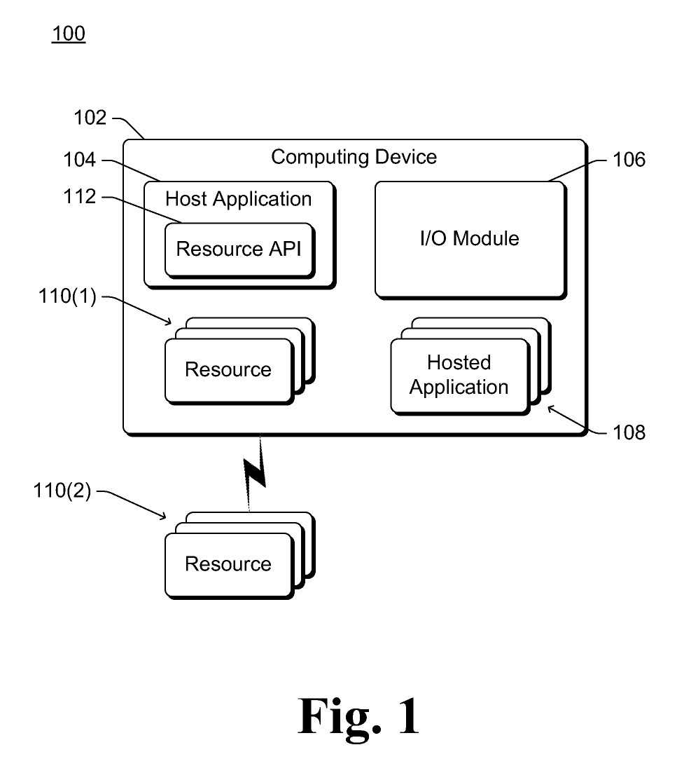

FIG. 1 illustrates an example system 100 implementing the user-controlled application access to resources in accordance with one or more embodiments. System 100 includes a computing device 102 that includes a host application 104, an input/output (I/O) module 106, one or more hosted applications 108, and one or more resources 110. System 100 also includes one or more resources 110 that are separate from computing device 102. As discussed in more detail below, resources 110 can be included as part of computing device 102 and/or can be coupled to computing device 102. Host application 104, I/O module 106, and hosted applications 108 are typically implemented on the same computing device, although alternatively can be implemented on different computing devices.

Computing device 102 can be a variety of different types of computing devices. For example, computing device 102 can be a desktop computer, a laptop or handheld computer, a notepad computer, a mobile station, an entertainment appliance, a set-top box communicatively coupled to a display device, a television, a cellular or other wireless phone, a game console, an audio and/or video playback device, an automotive computer, and so forth. Thus, computing device 102 can range from a full resource device with substantial memory and processor resources (e.g., personal computers, game consoles) to a low-resource device with limited memory and/or processing resources (e.g., traditional set-top boxes, hand-held game consoles).

I/O module 106 receives user inputs from a user of computing device 102. User inputs can be received in a variety of different manners, such as via a touchpad or touchscreen, via a keypad or keyboard, via a cursor control device, via a microphone, via physical feedback inputs (e.g., tapping a portion of computing device 102, or other detected motions such as shaking or rotating of computing device 102), and so forth. I/O module 106 also generates, manages, and/or outputs a user interface for computing device 102. This user interface displays or otherwise presents various information to a user of computing device 102, such as information to be displayed by host application 104 and/or one or more hosted applications 108. This user interface includes a display or screen that is generated, and can optionally include multiple different windows in which different applications (e.g., host application 104, hosted applications 108, etc.) can display information.

Host application 104, also referred to as a container, is an application that can manage running one or more other applications. These other applications are referred to as being hosted by or contained in host application 104, and in system 100 these other applications are hosted applications 108. Host application 104 can be, for example, an operating system, an Internet browser, a Java™ virtual machine or other virtual machines, a Silverlight™ development platform or other similar platforms, and so forth.

Hosted applications 108 run within host application 104. Hosted applications 108 can be stored at least temporarily on computing device 102, such as being downloaded or copied from a remote source. Hosted applications 108 can optionally be downloaded to computing device 102 and run while host application 104 is running, and then be removed from computing device 102. Hosted applications 108 can be, for example, web applications. A variety of different functionality can be provided by hosted applications 108, such as various productivity functionality (e.g., word processing functionality, spreadsheet functionality, etc.), communication functionality (e.g., phones service such as initiating voice phone calls, initiating teleconferences, etc.), gaming or other recreational functionality, and so forth.

Hosted applications 108 are also referred to as sandboxed applications because the environment in which they run is enclosed by host application 104. Host application 104 restricts hosted applications 108 to accessing only particular portions of computing device 102 (e.g., particular memory spaces, particular resources, and so forth). These restrictions can be implemented in different manners, such as by executing hosted applications 108 in a different privilege level than host application 104, executing hosted applications 108 in a particular portion of memory of computing device 102, and so forth. Hosted applications 108 are able to access other applications and/or resources of computing device 102 only when permitted to do so by host application 104.

Resources 110 can be included as part of computing device 102 and/or can be coupled to computing device 102. Generally, a resource refers to a component, module, or device that a hosted application 108 may attempt to access. Resources 110 are oftentimes hardware components, but can be any combination of software, hardware, and/or firmware. Resources 110 can be a variety of different types of resources, such as a microphone, a camera, global positioning system (GPS) sensors, accelerometers, temperature services, network storage devices, phone services, network services (e.g., network access), and so forth.

Resources 110 that are coupled to computing device 102 can be coupled to and communicate with computing device 102 in a variety of different manners. In one or more embodiments, computing device 102 communicates with resources 110 coupled to computing device 102 via a variety of different networks, such as the Internet, a local area network (LAN), a phone network, an intranet, other public and/or proprietary networks, combinations thereof, and so forth. Alternatively, computing device 102 can communicate with resources 110 coupled to computing device 102 using different protocols or technologies, such as universal serial bus (USB) connections, wireless USB connections, infrared connections, Bluetooth connections, and so forth.

Host application 104 includes a resource application programming interface (API) 112 and exposes resource API 112 to hosted applications 108. In order to access a desired resource 110, a hosted application 108 invokes resource API 112, identifying the resource 110 to which access is desired. The particular resource 110 to which access is desired can be identified, for example, as a parameter when invoking resource API 112. Alternatively, the particular resource 110 can be identified in other manners, such as resource API exposing different methods for different resources, so the particular resource 110 is inherently identified in the method invoked by the hosted application 108.

In one or more embodiments, host application 104 displays or otherwise presents, via I/O module 106, a set of visual representations of resources 110. These visual representations indicate, to a user of computing device 102, the different resources on computing device 102 that are available to host application 104. The particular resources that are available to host application 104 can be identified in different manners, such as based on information included in a registration store (e.g., an operating system registry) of computing device 102, configuration information included as part of or otherwise accessible to host application 104, and so forth. These visual representations of resources 110 are discussed herein as icons, although it should be noted that other visual representations can alternatively be used analogously to these icons, such as buttons, portions of a window, and so forth.

In one or more embodiments, host application 104 displays a different icon for each of the different resources 110 that are available to host application 104. Alternatively, host application 104 can be configured with, or otherwise have access to, configuration information indicating which icons are to be displayed. This configuration can optionally be changed by an administrator or other user of computing device 102. For example, a user may desire that one or more hosted applications 108 sometimes make use of a camera but do not make use of a microphone. Accordingly, the user can change the configuration information for host application 104 (e.g., via a user interface presented via host application 104 and I/O module 106) so that host application 104 does not display an icon representing a microphone.

The icons representing the different resources 110 can be displayed on an ongoing basis by host application 104 (although their appearance may be altered as discussed below). Alternatively, the icons representing the different resources 110 can be displayed, and then their display ceased, in response to different events. For example, the icons representing the different resources 110 can be displayed each time a request to access one of the resources is received by host application 104, during times when access to one of resources 110 has been granted to a hosted application 108, and so forth.

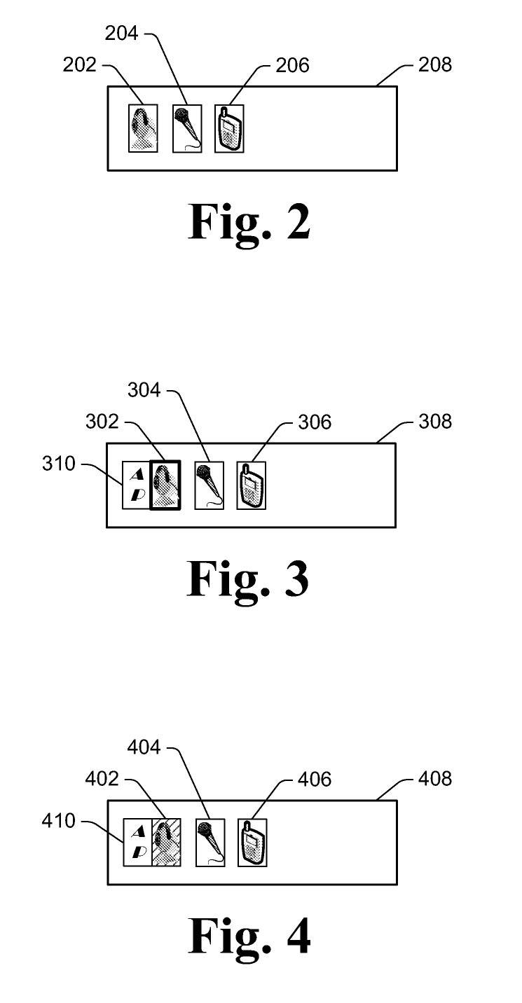

FIG. 2 illustrates an example display of icons 202, 204, and 206 in accordance with one or more embodiments. Icon 202 represents a resource that is a camera, icon 204 represents a resource that is a microphone, and icon 206 represents a resource that is a phone service. Thus, icons 202, 204, and 206 indicate to a user of the computing device displaying icons 202, 204, and 206 that the computing device has resources available to the host application that include a camera, a microphone, and a phone service.

In the example of FIG. 2, icons 202, 204, and 206 are illustrated as being included in a toolbar 208. Toolbar 208 can be displayed in a particular location of a display device (e.g., in the bottom right corner of the display), or alternatively in a particular location of a window (e.g., a window displayed by host application 104 of FIG. 1). Alternatively, icons 202, 204, and 206 can be displayed in other locations within a window displayed by host application 104 of FIG. 1, within a window displayed by a hosted application 108 of FIG. 1, or in other locations on a display. Icons 202, 204, and 206 can be displayed as a set or group as illustrated in FIG. 2, or alternatively different ones of icons 202, 204, and 206 can be displayed in different windows or other locations on a display.

Returning to FIG. 1, when a hosted application 108 desires to access a particular resource 110, the hosted application 108 invokes resource API 112, indicating the particular resource 110 to which the hosted application 108 desires access. In response to resource API 112 being invoked, host application 104 alters the appearance of the icon representing the particular resource 110 to which the hosted application 108 desires access. This altering of the appearance of the icon representing the particular resource 110 indicates to a user of computing device 102 that a hosted application 108 desires to access the resource represented by that icon.

The appearance of an icon can be altered in a variety of different manners to indicate to a user of computing device 102 that a hosted application 108 desires to access the resource represented by that icon. For example, the size, shape, color, or other characteristics of the icon or area surrounding the icon can be altered. By way of further example, the icon can be moved to a different location, a border or other region surrounding the icon can be changed, and so forth. By way of additional example, an animation can be added to the icon so that the icon appears to pulse or flash, glow, increase and/or decrease in size, and so forth.

Additionally, in response to resource API 112 being invoked, host application 104 can display an additional icon representing the particular hosted application 108 that is requesting access to the particular resource 110. The display of an additional icon representing the particular hosted application 108 indicates to a user of computing device 102 the particular hosted application 108 that desires to access the resource represented by that icon. This additional icon representing the particular hosted application 108 can be displayed in different locations, such as adjacent to the icon representing the particular resource 110 to which the hosted application desires access. The icon representing the particular hosted application 108 can also be displayed with an altered appearance, such as an appearance altered in the same manner as the icon representing the particular resource 110. For example, if the icon representing the particular resource 110 is altered to appear to pulse, then the icon representing the particular hosted application 108 can also be altered to appear to pulse. The particular hosted application 108 can also optionally display an indication (e.g., a dialog box or other written description) for the user to select the icon representing the particular resource 110 so that the hosted application 108 can access that particular resource 110.

Host application 104 can obtain an icon representing the particular hosted application 108 that desires to access the resource in a variety of different manners. In one or more embodiments, each hosted application 108 has an application identifier. This application identifier can be generated in a variety of different manners, such as by obtaining a hash value generated by applying a conventional hash function to one or more portions of the hosted application 108. Host application 104 accesses a record of icons associated with particular application identifiers, and obtains the icon associated with the host application 108 desiring to access the resource. This record can be maintained by host application 104, or alternatively by another component or module (e.g., the record can be included in a registration store, such as an operating system registry, of computing device 102). The record of associations of icons to application identifiers can be generated by host application 104, or alternatively another component, module, or device.

Alternatively, the icon associated with a particular hosted application 108 can be identified in other manners. In one or more embodiments, the hosted application 108 could provide the icon to host application 104 (e.g., as a parameter when invoking resource API 112) in a manner so that host application 104 trusts that the icon represents the hosted application 108. For example, hosted application 108 could provide an icon representing hosted application 108 that is digitally signed (e.g., using conventional public/private key cryptography techniques) by a party that is trusted by host application 104.

FIG. 3 illustrates an example display of icons 302, 304, and 306 in accordance with one or more embodiments. Icon 302 represents a resource that is a camera, icon 304 represents a resource that is a microphone, and icon 306 represents a resource that is a phone service. Icons 302, 304, and 306 of FIG. 3 correspond to icons 202, 204, and 206 of FIG. 2, respectively. In the example of FIG. 3, icons 302, 304, and 306 are illustrated as being included in a toolbar 308, although alternatively icons 302, 304, and 306 can be displayed in different locations analogous to icons 202, 204, and 206 of FIG. 2.

In FIG. 3, it is assumed that a host application 108 has requested access to a resource that is a camera. Accordingly, the appearance of the icon representing the camera (icon 202 in FIG. 2) is altered, resulting in icon 302 of FIG. 3. The appearance of the icon representing the camera is altered to draw the attention of the user to the icon representing the camera resource. In the example of FIG. 3, the appearance of icon 202 of FIG. 2 is altered by changing the size or brightness of a border surrounding the icon. However, the appearance of icon 202 can alternatively be altered in different manners as discussed above.

Additionally, an icon 310 representing the hosted application (e.g., a hosted application 108 of FIG. 1) that desires access to the camera is displayed. Thus, toolbar 308 readily indicates to a user of the computing device that the hosted application represented by icon 310 desires to access the camera of the computing device (represented by icon 302 having an altered appearance).

Alternatively, no icon 310 need be displayed. Thus, an icon having its appearance altered to indicate that a hosted application desires access to the camera is displayed, but an icon identifying the particular hosted application is not displayed.

Returning to FIG. 1, a user selection of the icon representing the particular resource to which the particular hosted application desires access indicates that the user authorizes the particular hosted application to access the particular resource. This user selection of the icon representing the particular resource can optionally include user selection of the icon representing the hosted application (e.g., the user may select icon 310 of FIG. 3 in addition to or in place of icon 302). A variety of different user inputs as discussed above can be received to indicate a user selection of the icon. For example, the user can touch the icon with his or her finger or a stylus, the user can navigate a cursor over the icon using a cursor control device and press a button of the cursor control device (e.g., click a mouse button), and so forth.

If a user selection of the icon representing the particular resource to which the particular hosted application desires access is received, then host application 104 grants that particular hosted application access to that particular resource. The manner in which access to the particular resource is granted to the particular hosted application can vary. For example, host application 104 can pass communications between the particular hosted application and the particular resource, or can elevate the particular hosted application to a privilege level that is permitted to access the particular resource. By way of another example, host application 104 can provide a key or other identifier to the particular hosted application that the particular hosted application can in turn provide to the particular resource so that the particular resource will communicate with the particular hosted application. By way of yet another example, host application 104 can notify an operating system of computing device 102 that the particular hosted application is permitted to access the particular resource.

Additionally, if a user selection of the icon representing the particular resource to which the particular hosted application desires access is received, then host application 104 again alters the appearance of the icon representing the particular resource to indicate that access to the resource represented by the icon has been granted. The appearance of the icon can be altered in a variety of different manners, analogous to the discussion above regarding altering the appearance of the icon to indicate to a user of computing device 102 that a hosted application 108 desires to access the resource represented by that icon.

Thus, it should be noted that the icon representing a particular resource can have three different appearances. A first appearance indicates to a user of the computing device that no hosted application is requesting access to the resource and no hosted application has access to the resource. A second appearance indicates to a user of the computing device that a hosted application has requested access to the resource but that access to the resource has not yet been granted. A third appearance indicates to a user of the computing device that a hosted application has been granted access to the resource.

FIG. 4 illustrates an example display of icons 402, 404, and 406 in accordance with one or more embodiments. Icon 402 represents a resource that is a camera, icon 404 represents a resource that is a microphone, and icon 406 represents a resource that is a phone service. Icons 402, 404, and 406 of FIG. 4 correspond to icons 202, 204, and 206 of FIG. 2, respectively. In the example of FIG. 4, icons 402, 404, and 406 are illustrated as being included in a toolbar 408, although alternatively icons 402, 404, and 406 can be displayed in different locations analogous to icons 202, 204, and 206 of FIG. 2.

In FIG. 4, it is assumed that a host application 108 has been granted access to a resource that is a camera. Accordingly, the appearance of the icon representing the camera (icon 202 in FIG. 2 and icon 302 in FIG. 3) is altered again, resulting in icon 402 of FIG. 4. In the example of FIG. 4, the appearance of icon 302 of FIG. 3 is altered by changing the background or color of the icon. However, the appearance of icon 302 can alternatively be altered in different manners as discussed above.

Additionally, an icon 410 representing the hosted application (e.g., a hosted application 108 of FIG. 1) that was granted access to the camera is displayed. Thus, toolbar 408 readily indicates to a user of the computing device that the hosted application represented by icon 410 has access to the camera of the computing device (represented by icon 402 having the further or additionally altered appearance).

Returning to FIG. 1, if a user selection of the icon representing the particular resource to which the particular hosted application desires access is not received, then host application 104 does not grant that particular hosted application access to that particular resource. In one or more embodiments, host application 104 waits a threshold amount of time (such as twenty seconds) after displaying the icon representing the particular resource to which the particular hosted application desires access with an altered appearance. If a user selection of the icon with the altered appearance is not received within that threshold amount of time, then host application 104 returns to displaying the icon with an unaltered appearance (e.g., as illustrated in FIG. 2).

Host application 104 can optionally impose an additional threshold amount of time (e.g., one minute) before altering the appearance of the icon again. For example, if a hosted application requested access to a particular resource and was not granted access to that particular resource, host application 104 would not alter the appearance of the icon and accept a user selection of the icon until the additional threshold amount of time (e.g., one minute) has elapsed. This additional threshold amount of time can apply to all hosted applications 108, or alternatively only to the hosted application that requested but was not granted access to that particular resource.

After a particular hosted application 108 has been granted access to a particular resource, that grant can be terminated in response to a variety of different events. In one or more embodiments, the grant is maintained until the particular hosted application 108 stops running or host application 104 stops running (in which case hosted application 108 stops running as well). In other embodiments, the hosted application 108 can voluntarily release the grant (e.g., by notifying host application 104, such as via resource API 112), or can be forced to release the grant (e.g., by host application 104 or another component or module of computing device 104) in response to a variety of different events. For example, in response to a user selection of an icon representing a particular hosted application (e.g., icon 410 of FIG. 4), or an icon representing the particular resource (e.g., icon 402 of FIG. 4), host application 104 can terminate the grant of access to the particular resource. The manner in which host application 104 terminates the grant of access to the particular resource can vary, such as reducing the hosted application to a privilege level that is not permitted to access the particular resource, ceasing passing of communications between the hosted application and the particular resource, notifying an operating system of computing device 102 that the particular hosted application is no longer permitted to access the particular resource, and so forth.

FIGS. 2, 3, and 4 illustrate an example in which a single hosted application 108 requests and is granted access to a particular resource. It should be noted that additional requests to access different resources can be received from the same or different hosted applications, and that the appearance of the icons representing those different resources can be altered analogous to the discussion above. Similarly, icons representing the particular hosted applications desiring access to (or being granted access to) those different resources can be displayed analogous to the discussion above.

In one or more embodiments, host application 104 grants access to a particular resource to a single hosted application 108 at a time. Alternatively, host application 104 can grant access to a particular resource to multiple hosted applications 108, allowing multiple hosted applications 108 to concurrently access the particular resource. Such a request and grant can be performed analogous to the discussion above. For example, after granting access to a particular resource to a first hosted application 108, a second request to access the same resource can be received from a second hosted application 108. The appearance of the icon representing that particular resource can be altered (e.g., as discussed above with reference to FIG. 3), and an icon representing the second hosted application 108 can also be displayed (e.g., analogous to the discussion above regarding FIG. 3). The appearance of the icon representing the second hosted application 108 can optionally be altered in the same manner as the icon representing the particular resource to readily identify to a user of the computing device the identity of the second hosted application 108. If a user selection of the icon representing the particular resource is received, then the second hosted application 108 is granted access to the particular resource (concurrently with the first hosted application 108) and the appearance of the icon representing that particular resource is again altered (e.g., as discussed above with reference to FIG. 4). Otherwise, the second hosted application 108 is not granted access to the particular resource and the appearance of the icon representing that particular resource is again altered (e.g., as discussed above with reference to FIG. 4, except that no icon representing the second hosted application 108 is displayed) because access to the particular resource is still granted to the first hosted application 108.

In one or more embodiments, a user may also be able to select icons that are displayed but do not represent a resource for which a hosted application currently desires access. Such user selections can be resolved by host application 104 in different manners, such as ignoring the user selections, displaying or otherwise presenting an indication that no hosted application is requesting access to the resource represented by the selected icon, and so forth.

In one or more embodiments, the icons representing the resources are displayed in an area of a display or screen that cannot be written to directly by hosted applications 108. Such an area can be, for example, a toolbar in a window displayed by host application 104, a portion of a window displayed by a hosted application 108, and so forth. A hosted application 108 may optionally be able to indirectly write to the area of the display or screen in which the icons representing the resources are displayed, such as by submitting a request to host application 104 to write to that area of the display or screen. However, such requests would typically be denied by host application 104.

Displaying icons representing the resources in an area of the display or screen that cannot be written to directly by hosted applications 108 prevents a malicious hosted application 108 from overwriting a particular icon. For example, a malicious hosted application 108 may desire to overwrite an icon representing a camera with another icon in an attempt to trick a user of computing device 102 into selecting an icon representing the camera. Such an attempt, however, would be unsuccessful because the malicious hosted application is not able to overwrite the icon.

Furthermore, displaying icons representing the resources in an area of the display or screen that cannot be written to directly by hosted applications 108 prevents a hosted application 108 itself from selecting an icon. The hosted applications 108 cannot access that area of the display or screen, and thus cannot select an icon. Alternatively, host application 104 can identify user selections based on indications of user inputs received from I/O module 106. If a malicious hosted application 108 were to provide an indication of a user input in an attempt to obtain access to a particular resource without a user selection of the icon representing that particular resource, the indication is ignored by host application 104 as the request is not received from I/O module 106.

Thus, it can be seen that which hosted applications are granted access to which particular resources is under the control of the user of the computing device. Access is granted in response to a user selection of a particular icon as discussed above, not in response to other events or actions.

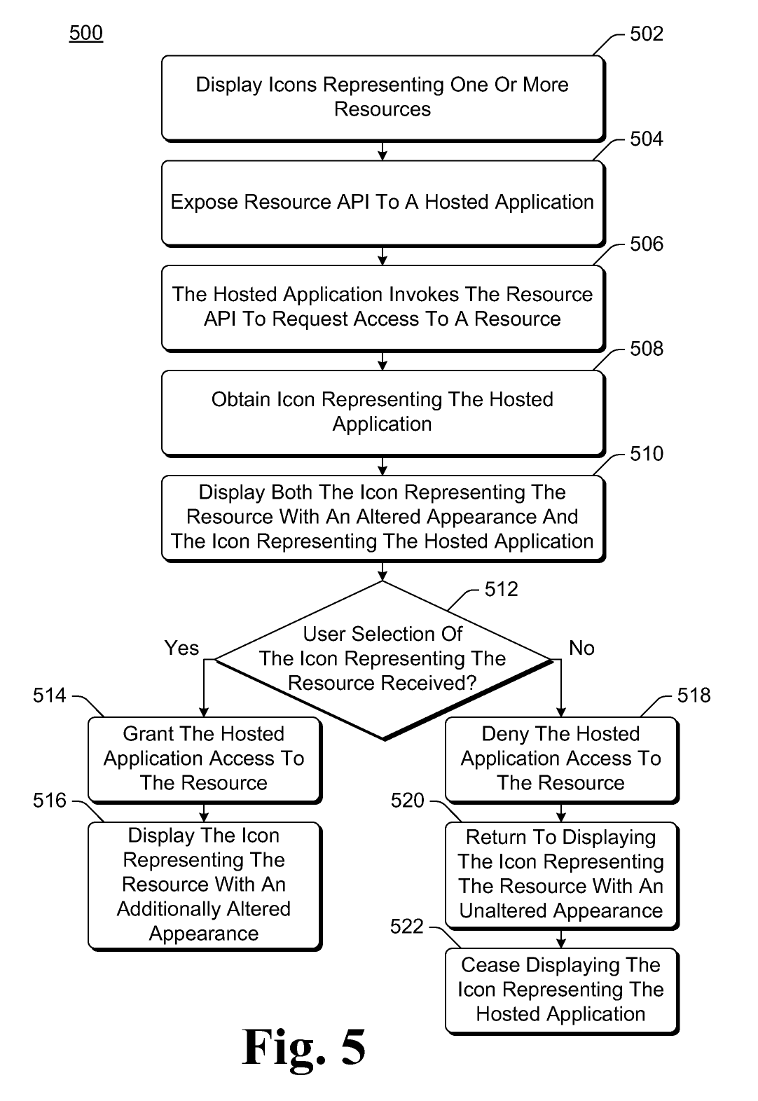

FIG. 5 is a flowchart illustrating an example process 500 for user-controlled application access to resources in accordance with one or more embodiments. Process 500 is carried out by a device, such as computing device 102 of FIG. 1, and can be implemented in software, firmware, hardware, or combinations thereof. Process 500 is shown as a set of acts and is not limited to the order shown for performing the operations of the various acts. Process 500 is an example process for user-controlled application access to resources; additional discussions of user-controlled application access to resources are included herein with reference to different figures.

In process 500, icons representing one or more resources are displayed (act 502). These resources are resources available to a host application, and the icons are displayed by the host application as discussed above.

The host application exposes a resource API (act 504). This resource API can be invoked by hosted applications to request access to resources available to the host application, as discussed above.

Eventually, a hosted application invokes the resource API to request access to a particular resource (act 506). The hosted application identifies the particular resource when invoking the resource API, such as passing an indication of the particular resource as a parameter when invoking the resource API.

An icon representing the hosted application making the request is obtained (act 508). This icon can be obtained in a variety of different manners as discussed above.

The icon representing the resource is displayed with an altered appearance, and the icon representing the hosted application is also displayed (act 510). The appearance of the icon representing the resource can be altered in different manners as discussed above.

Process 500 proceeds based on whether a user selection of the icon representing the resource is received (act 512). This user selection can be received in a variety of different manners as discussed above.

If the user selection of the icon representing the resource is received, then the hosted application is granted access to the resource (act 514), and the icon representing the resource is displayed with an additionally altered appearance (act 516). The icon representing the resource can be additionally altered (altered again as discussed above) in act 516 in a variety of different manners as discussed above. The icon representing the hosted application can optionally continue to be displayed in act 516, or alternatively displaying of the icon representing the hosted application can cease in act 516. The icon representing the resource continues to be displayed in act 516 until the hosted application is no longer granted access to the application, at which point the display of the icon returns to its original unaltered appearance (e.g., as displayed in act 502).

Returning to act 512, if the user selection of the icon representing the resource is not received, then the hosted application is denied (not granted) access to the resource (act 518). Display of the icon returns to its original unaltered appearance (act 520), such as its appearance as displayed act 502. Displaying of the icon representing the hosted application also ceases (act 522).

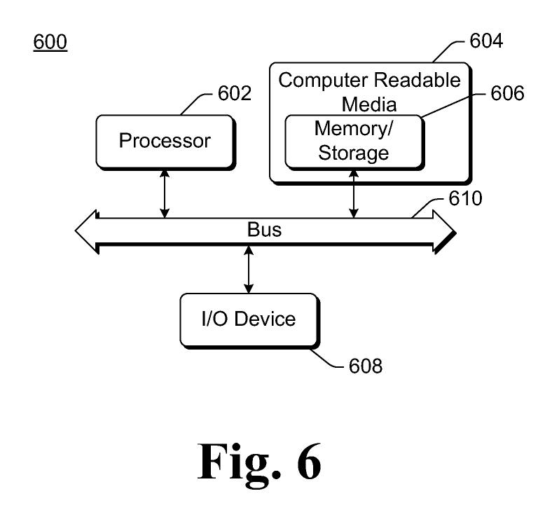

FIG. 6 illustrates an example computing device 600 that can be configured to implement the user-controlled application access to resources in accordance with one or more embodiments. Computing device 600 can be, for example, computing device 102 of FIG. 1.

Computing device 600 includes one or more processors or processing units 602, one or more computer readable media 604 which can include one or more memory and/or storage components 606, one or more input/output (I/O) devices 608, and a bus 610 that allows the various components and devices to communicate with one another. Computer readable media 604 and/or one or more I/O devices 608 can be included as part of, or alternatively may be coupled to, computing device 600. Bus 610 represents one or more of several types of bus structures, including a memory bus or memory controller, a peripheral bus, an accelerated graphics port, a processor or local bus, and so forth using a variety of different bus architectures. Bus 610 can include wired and/or wireless buses.

Memory/storage component 606 represents one or more computer storage media. Component 606 can include volatile media (such as random access memory (RAM)) and/or nonvolatile media (such as read only memory (ROM), Flash memory, optical disks, magnetic disks, and so forth). Component 606 can include fixed media (e.g., RAM, ROM, a fixed hard drive, etc.) as well as removable media (e.g., a Flash memory drive, a removable hard drive, an optical disk, and so forth).

The techniques discussed herein can be implemented in software, with instructions being executed by one or more processing units 602. It is to be appreciated that different instructions can be stored in different components of computing device 600, such as in a processing unit 602, in various cache memories of a processing unit 602, in other cache memories of device 600 (not shown), on other computer readable media, and so forth. Additionally, it is to be appreciated that the location where instructions are stored in computing device 600 can change over time.

One or more input/output devices 608 allow a user to enter commands and information to computing device 600, and also allows information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embody computer readable instructions, data structures, program modules, or other data in a modulated data signal, such as carrier wave or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above are also included within the scope of computer readable media.

Generally, any of the functions or techniques described herein can be implemented using software, firmware, hardware (e.g., fixed logic circuitry), manual processing, or a combination of these implementations. The terms “module” and “component” as used herein generally represent software, firmware, hardware, or combinations thereof. In the case of a software implementation, the module or component represents program code that performs specified tasks when executed on a processor (e.g., CPU or CPUs). The program code can be stored in one or more computer readable memory devices, further description of which may be found with reference to FIG. 6. The features of the user-controlled application access to resources techniques described herein are platform-independent, meaning that the techniques can be implemented on a variety of commercial computing platforms having a variety of processors.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
displaying an icon representing a resource;
receiving, from an application, a request to access the resource;
altering, in response to the request, an appearance of the icon representing the resource; and
granting, to the application, access to the resource only if a user selection of the icon is received.

2. A method as recited in claim 1, wherein altering the appearance of the icon comprises displaying the icon with an appearance of the icon flashing.

3. A method as recited in claim 1, further comprising altering the appearance of the icon again in response to receiving the user selection of the icon.

4. A method as recited in claim 3, wherein altering the appearance of the icon again comprises displaying the icon with an appearance of the icon glowing.

5. A method as recited in claim 1, wherein receiving the request comprises the application invoking an application programming interface (API) exposed by a host application that hosts the application.

6. A method as recited in claim 5, wherein receiving the request further comprises receiving an identification of the resource as a parameter of the API.

7. A method as recited in claim 1, further comprising returning to displaying the icon without an altered appearance if the user selection of the icon is not received within a threshold amount of time.

8. A method as recited in claim 1, wherein the resource comprises a camera.

9. A method as recited in claim 1, wherein the resource comprises a phone service.

10. A method as recited in claim 1, further comprising displaying, adjacent to the icon representing the resource, an icon representing the application.

11. A method as recited in claim 1, further comprising returning, after access to the resource granted to the application has terminated, to displaying the icon without the appearance of the icon being altered.

12. One or more computer storage media having stored thereon multiple instructions that implement a host application and that, when executed by one or more processors of a computing device, cause the one or more processors to:
receive, from one of one or more applications hosted by the host application, a request to access a resource of the computing device;
display a visual representation of the resource with an altered appearance that is different than if the request to access the resource were not received; and
allow the one application to access the resource only if a user selection of the visual representation is received.

13. One or more computer storage media as recited in claim 12, wherein the multiple instructions further cause the one or more processors to display, in response to receiving the user selection of the visual representation, the visual representation with a further altered appearance that is different than the altered appearance and also different than if the request to access the resource were not received.

14. One or more computer storage media as recited in claim 13, wherein to display the visual representation with the altered appearance is to display the visual representation as flashing, and wherein to display the visual representation with a further altered appearance is to display the visual representation as glowing.

15. One or more computer storage media as recited in claim 12, wherein to receive the request is to receive an identification of the resource as a parameter of an application programming interface (API) exposed by the host application and invoked by the one application.

16. One or more computer storage media as recited in claim 12, wherein the multiple instructions further cause the one or more processors to display, adjacent to the visual representation representing the resource, a visual representation of the one application.

17. One or more computer storage media as recited in claim 12, wherein the multiple instructions further cause the one or more processors to:
receive, from the one application, an additional request to access an additional resource of the computing device;
display, concurrent with the display of the visual representation of the resource, an additional visual representation representing the additional resource with an altered appearance that is different than if the additional request to access the additional resource were not received; and
allow the one application to access the additional resource only if a user selection of the additional visual representation is received.

18. One or more computer storage media as recited in claim 12, wherein the multiple instructions are to:
display the visual representation of the resource with a first appearance if none of the one or more applications is requesting access to the resource and none of the one or more applications have access to the resource;
display the visual representation of the resource with a second appearance if the one application has requested access to the resource but has not yet been granted access to the resource, wherein the second appearance is altered from the first appearance; and
display the visual representation of the resource with a third appearance if the one application has been granted access to the resource, wherein the third appearance is altered from the first appearance and from the second appearance.

19. One or more computer storage media as recited in claim 12, wherein the multiple instructions further cause the one or more processors to display, after access to the resource granted to the one application has been terminated, the visual representation having an appearance as if the request to access the resource were not received.

20. A method implemented in a container application that hosts one or more applications, the method comprising:
displaying multiple icons, each of the multiple icons representing one of multiple resources;
receiving, from one of the one or more applications, a request to access one of the multiple resources;
indicating, in response to the request, that the request to access the one resource has been received by altering an appearance of the one of the multiple icons representing the one resource;
indicating, in response to the request, that the request to access the one resource has been received from the one application by displaying, adjacent to the one icon, an application icon representing the application; and
if a user selection of the one icon is received within a threshold amount of time, then:
granting, to the one application, access to the one resource; and
indicating that the request to access the one resource to the one application has been granted by altering the appearance of the one icon again; and
if the user selection of the one icon is not received within the threshold amount of time, then:
not granting, to the one application, access to the one resource; and
indicating that the request to access the one resource has not been granted by returning to displaying the one icon with an unaltered appearance, and ceasing displaying the application icon.
